(19) United States
(12) Patent Application Publication
(10) Pub. No.: US 2015/0207742 A1
(43) Pub. Date: Jul. 23, 2015

(54) METHODS FOR OPTIMIZING DATA FOR TRANSMISSION AND DEVICES THEREOF

(71) Applicant: Wipro Limited, Bangalore (IN)

(72) Inventors: Raghavendra Hosabettu, Bangalore (IN); Mallirajan Selvarajan, Bangalore (IN); Sandeep Sudarshan Davengere, Bangalore (IN)

(73) Assignee: Wipro Limited, Bangalore (IN)

(21) Appl. No.: 14/200,478

(22) Filed: Mar. 7, 2014

(30) Foreign Application Priority Data
Jan. 22, 2014 (IN) 281/CHE/2014

(51) Int. Cl. H04L 12/815; H04L 29/08; H04L 29/06

(52) U.S. Cl. CPC H04L 47/22; H04L 67/42; H04L 67/322

(57) ABSTRACT

A method, non-transitory computer readable medium and data optimizing computing device for optimizing data for transmission obtaining data set for transmission. One or more configuration rules associated with the obtained data set are obtained. The obtained data set is optimized based on the obtained one or more configuration rules for transmission. A client code and a server code associated with the optimized data set are generated. At least one of the generated client code is transmitted to a client computing device or the server code is transmitted to a server computing device.

This application claims the benefit of Indian Patent Application Filing Number 281/CHE/2014 filed on Jan. 22, 2014, which is hereby incorporated by reference in its entirety.

### FIELD

This technology relates to data management and, more particularly, to methods for optimizing data for transmission and devices thereof.

### BACKGROUND

All around technological advancements in the field of digital electronics, communication and IT are driving rapid digitization of data. The traditional conducts of businesses are getting radically transformed through the use of information technology. Accordingly, technologies for storage, computing and transmission are also trying to keep pace with this development so that the user experience meets the quality of service.

Existing technologies assist with storing and handling of large amounts of data. However, users and network administrators require real-time access to data or require real-time responses to a service request from data servers. Existing technologies assists these requirements by transmitting large amounts of data over the network having a limited bandwidth. Unfortunately, transferring data over a low bandwidth network becomes a challenge because the data transaction between systems connected over a network without optimization badly deteriorates the user experience.

### SUMMARY

A method for optimizing data for transmission includes a data optimizing computing device obtaining data set for transmission. One or more configuration rules associated with the obtained data set are obtained by the data optimizing computing device. The obtained data set is optimized by the data optimizing computing device based on the obtained one or more configuration rules for transmission. A client code and a server code associated with the optimized data set are generated by the data optimizing computing device. At least one of the generated client code is transmitted to a client computing device or the server code is transmitted to a server computing device by the data optimizing computing device.

A data optimizing computing device comprising a memory coupled to one or more processors which are configured to execute programmed instructions stored in the memory including obtaining data set for transmission. One or more configuration rules associated with the obtained data set are obtained. The obtained data set is optimized based on the obtained one or more configuration rules for transmission. A client code and a server code associated with the optimized data set are generated. At least one of the generated client code is transmitted to a client computing device or the server code is transmitted to a server computing device.

A non-transitory computer readable medium having stored thereon instructions for optimizing data for transmission comprising machine executable code which when executed by at least one processor, causes the processor to perform steps including obtaining data set for transmission. One or more configuration rules associated with the obtained data set are obtained. The obtained data set is optimized based on the obtained one or more configuration rules for transmission. A client code and a server code associated with the optimized data set are generated. At least one of the generated client code is transmitted to a client computing device or the server code is transmitted to a server computing device.

This technology provides a number of advantages including providing more effective methods, non-transitory computer readable medium and devices for optimizing data for transmission. Additionally, this technology provides advantages of transmitting optimized data which requires less bandwidth thereby increasing the service provided to the users. Further, by optimizing and then transmitting the data, the technology also provides advantages of significantly reducing the size of the data being transmitted.

### BRIEF DESCRIPTION OF THE DRAWINGS

FIG. 1 is an exemplary network environment comprising a data optimizing computing device for optimizing data for transmission;

FIG. 2 is an exemplary functional block diagram of the data optimizing computing device;

FIG. 3 is an exemplary flowchart for a method for optimizing data for transmission;

FIG. 4 is an illustration of an exemplary data set;

FIG. 5 is an illustration of the exemplary data set represented in a JSON format;

FIG. 6 is an exemplary flowchart illustrating the methods for optimizing data; and

FIG. 7 is an illustration of an exemplary optimized data.

### DETAILED DESCRIPTION

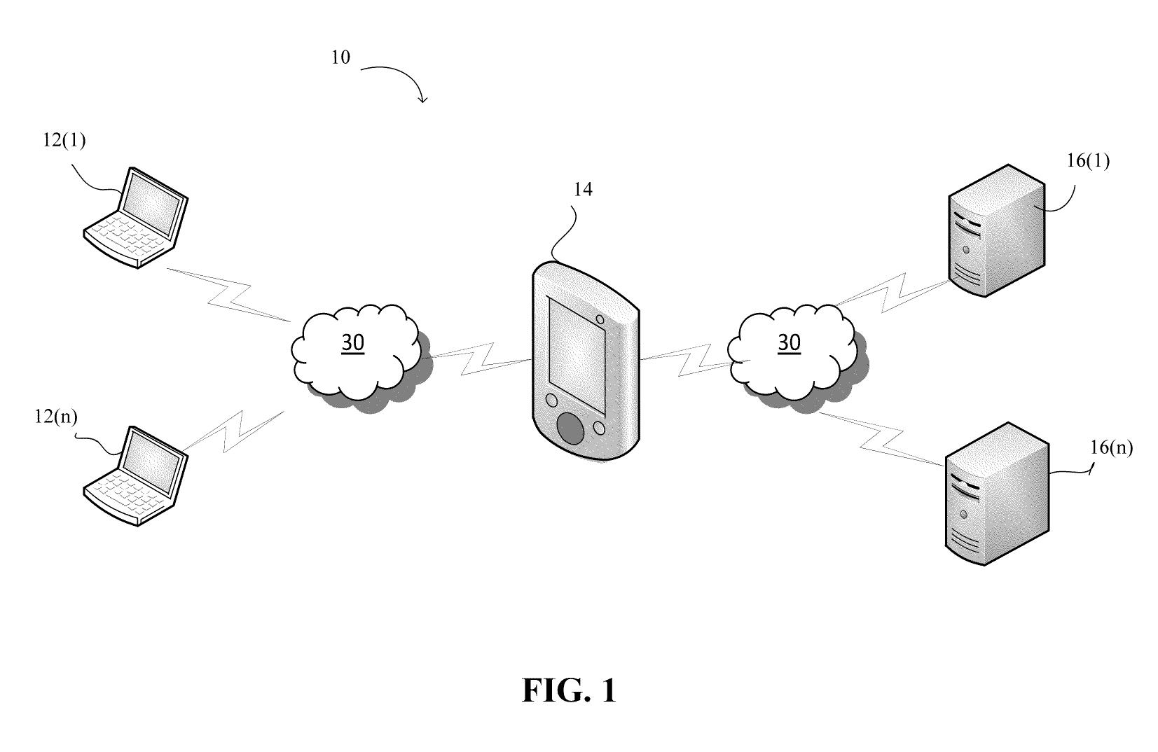

An exemplary network environment 10 with a data optimizing computing device 14 for optimizing data for transmission is as illustrated in FIG. 1. The exemplary network environment 10 includes a plurality of client computing devices 12(1)-12(n), the data optimizing computing device 14, and a plurality of servers 16(1)-16(n) which are coupled together by the communication networks 30, although the environment can include other types and numbers of devices, components, elements and communication networks in a variety of other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices optimizing data for transmission.

Referring more specifically to FIG. 1, data optimizing computing device 14 interacts with the client computing devices 12(1)-12(n) and servers 16(1)-16(n) through the communication networks 30, although the data optimizing computing device 14 can interact with the client computing devices 12(1)-12(n) and the servers 16(1)-16(n) using other methods or techniques. Communication networks 30 and the secured private network 31 include local area networks (LAN), wide area network (WAN), 3G technologies, GPRS or EDGE technologies, although the communication networks 30 can include other types and numbers of networks and other network topologies.

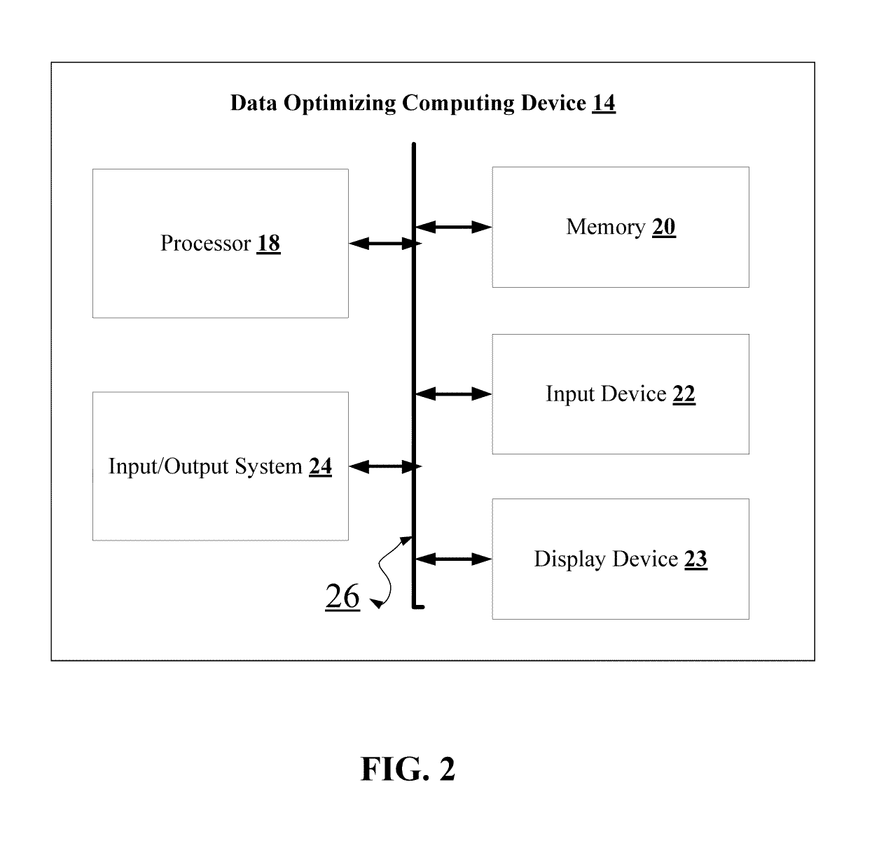

The data optimizing computing device 14 manages optimizing data for transmission within a network environment 10 as illustrated and described with the examples herein, although data optimizing computing device 14 may perform other types and numbers of functions and in other types of networks. As illustrated in FIG. 2, the data optimizing computing device 14 includes at least one processor 18, memory 20, input device 22 and display device 23, and input/output (I/O) system 24 which are coupled together by bus 26, although data optimizing computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

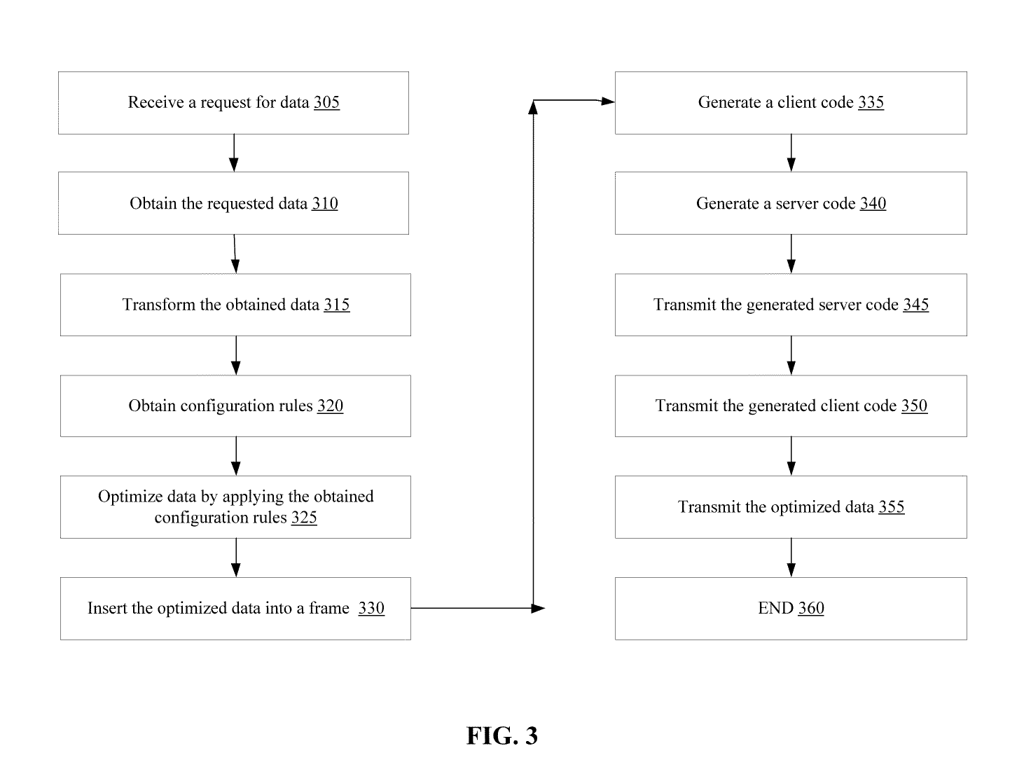

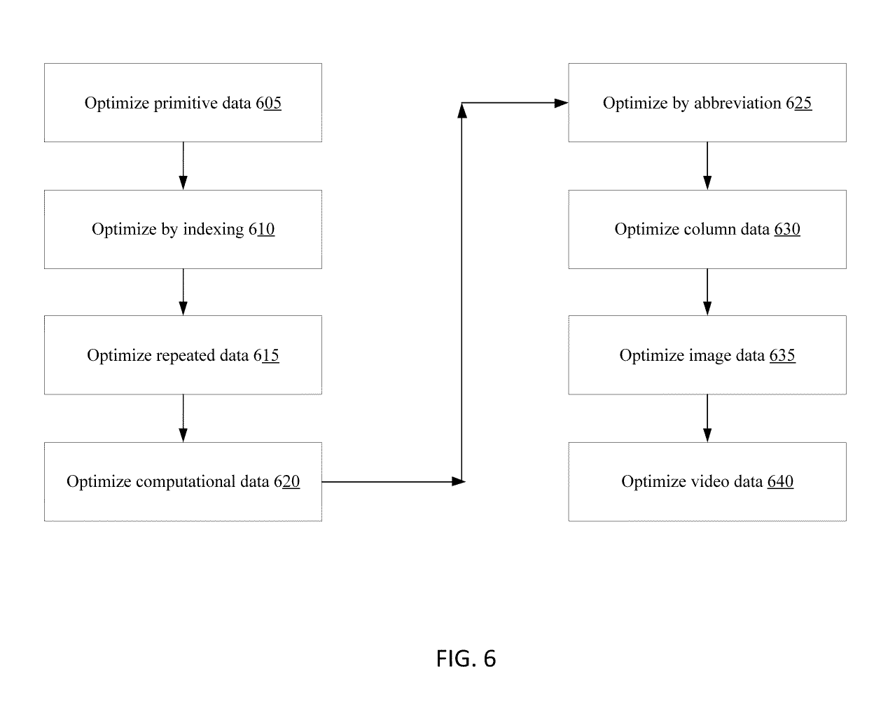

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. The flow charts shown in FIGS. 3 and 6 are representative of example steps or actions of this technology that may be embodied or expressed as one or more non-transitory computer or machine readable having stored instructions stored in memory 20 that may be executed by the processor(s) 18.

Input device 22 enables a user, such as an administrator, to interact with the data optimizing computing device 14, such as to input and/or view data and/or to configure, program and/or operate it by way of example only. By way of example only, input device 22 may include one or more of a touch screen, keyboard and/or a computer mouse.

The display device 23 enables a user, such as an administrator, to interact with the data optimizing computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

The I/O system 24 in the data optimizing computing device 14 is used to operatively couple and communicate between the data optimizing computing device 14, the client computing devices 12(1)-12(n) and the servers 16(1)-16(n) and which are all coupled together by communication network 30. In this example, the bus 26 is a hyper-transport bus in this example, although other bus types and links may be used, such as PCI.

Each of the client computing devices 12(1)-12(n) includes a central processing unit (CPU) or processor, a memory, an interface device, and an I/O system, which are coupled together by a bus or other link, although other numbers and types of network devices could be used. Each of the client computing devices 12(1)-12(n) communicate with the data optimizing computing device 14 through the servers 16(1)-16(n), although the client computing devices 12(1)-12(n) can interact with the data optimizing computing device 14 by other techniques. Additionally, in this example, the client computing devices 12(1)-12(n) interacts with the servers 16(1)-16(n) through a private secured network such as a VPN, although the client computing devices 12(1)-12(n) can interact with the servers 16(1)-16(n) via other network topologies such as semi-private or public topology. The client computing devices 12(1)-12(n) may run interface application(s), such as a Web browser, that may provide an interface to make requests for and receive content and/or communicate with web applications stored on the servers 106(1)-106(n) via the communication network 30.

The network environment 10 also includes plurality of servers 16(1)-16(n). Each of the plurality of servers 16(1)-16(n) includes a central processing unit (CPU) or processor, a memory, an interface device, and an I/O system, which are coupled together by a bus or other link, although other numbers and types of network devices could be used. Each of the plurality of servers 16(1)-16(n) communicate with the data optimizing computing device 14 through communication network 30, although the servers 16(1)-16(n) can interact with the data optimizing computing device 14 by other techniques. Various network processing applications, such as CIFS applications, NFS applications, HTTP Web Server applications, and/or FTP applications, may be operating on the servers 16(1)-16(n) and transmitting content (e.g., files, Web pages) to the client computing devices 12(1)-12(n) or the data optimizing computing device 14 in response to the requests.

Although an exemplary telecommunications network environment 10 with the multiple client computing devices 12(1)-12(n), data optimizing computing device 14 and multiple servers 16(1)-16(n) are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for optimizing data for transmission will now be described with reference to FIGS. 1-7. In step 305, the data optimizing computing device 14 receives a request for data from one of the client computing device 12(1)-12(n), although the data optimizing computing device can receive other types of requests from other devices.

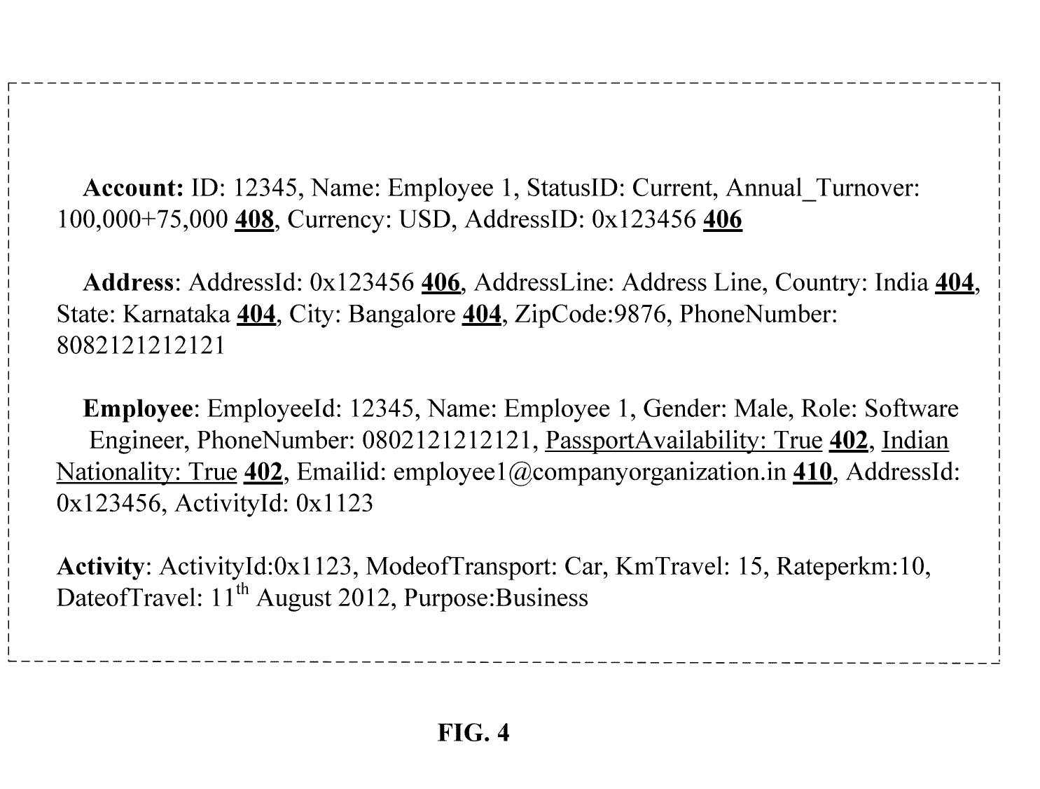

In step 310, the data optimizing computing device 14 responsive to the received request obtains the requested data from a database (not shown), although the data optimizing computing device 14 can obtain the requested data from other devices, such as the server 16(1)-16(n) by way of example only. Additionally, by way of example only, the data obtained by the data optimizing computing device 14 is in a format as illustrated in FIG. 4, although the obtained data can be of any other format.

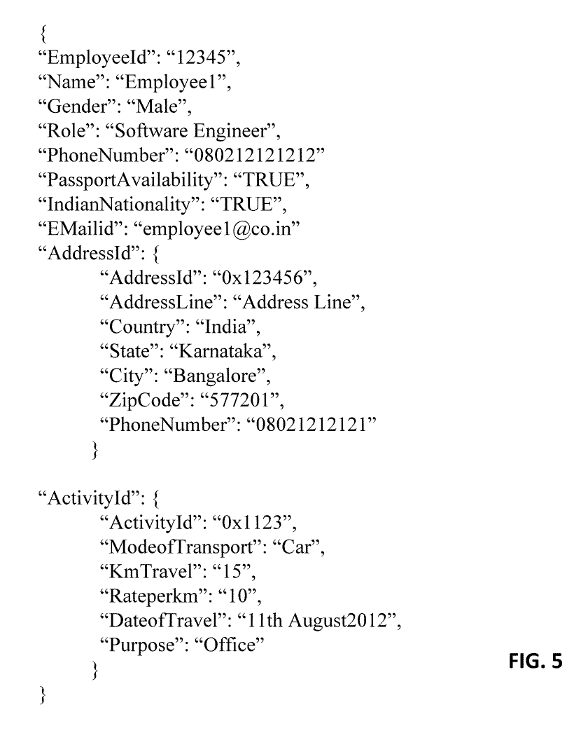

In step 315, the data optimizing computing device 14 transforms the obtained data illustrated in FIG. 4 to a XML or a JSON format, although the data optimizing computing device 14 can transform the obtained data to other formats. In this example, the data optimizing computing device 14 transforms the obtained data to XML or JSON format so that optimizing the different types of information present within the obtained data may be done effectively, although other types of transformations could be used. By way of example only, the obtained data illustrated in FIG. 4 is transformed by the data optimizing computing device 14 to JSON format as illustrated in FIG. 5.

In step 320, the data optimizing computing device 14 obtains one or more configuration rules required for optimizing the obtained data from the memory 20, although the data optimizing computing device 14 can obtain the one or more configuration rules from other memory locations. In this example, the one or more configuration rules define the instructions for optimizing each type of information present within the obtained data, although the configuration rules can provide other types of instructions.

In step 325, the data optimizing computing device 14 applies the obtained configuration rules on the obtained data set to optimize the obtained data using techniques which will now be illustrated with reference to FIG. 6, although the data optimizing computing device 14 can apply the configuration rules using other techniques. In this example, the data optimizing computing device 14 can perform one or more optimizing techniques illustrated below based on the type or format of the obtained data.

In step 605, the data optimizing computing device 14 identifies one or more primitive data present within the obtained data illustrated in FIG. 4 and optimizes the identified primitive data. In this example, primitive data relates to Boolean values, such as True or False, present within the obtained data set. By way of example only, Passport Availability: True and Indian Nationality: True data illustrated in FIG. 4 referenced by 402, illustrates examples of primitive data present within the obtained data set. For purpose of further illustration and by way of example only, if passport availability, Indian nationality and eligibility for work permit in the US are true (which in this example is represented by 1) and previous visit to the US and any prior work experience are false (represented by 0), the data optimizing computing device 14 converts the primitive data to values such as 0×13 which is a hexadecimal representation as shown in the table below.

| | | | Passport | Indian | | Hexa- |
|---|---|---|---|---|---|---|
| | Previous | Prior work | avail- | nation- | Work | decimal |
| | US visit | experience | ability | ality | permit | value |
| User 1 | 0 | 0 | 1 | 1 | 1 | 0x13 |

As illustrated above in this example, the data optimization computing device 14 converts the true or false values of the data to corresponding binary format and the final optimized data is the hexadecimal value of the boolean value, although the data optimization computing device 14 can optimize the primitive data using other techniques.

In step 610, the data optimizing computing device 14 identifies any indexed data present within the obtained data illustrated in FIG. 4 and optimizes the identified indexed data. By way of example only, indexed data may relate to information such as Country, State or City, although the indexed data can be other types or amounts of information within the obtained data. In this example, the data optimizing computing device optimizes the index data by replacing the indexed data with a corresponding index values stored in an index table. By way of example only, an index table can include country, state and/or city and their corresponding index values, although the index table can include other types or amounts of information. By way of example only, the data optimizing computing device 14 identifies “Country: India, State: Karnataka, City: Bangalore” referenced by 404 as indexed data and replaces the India by 91 (which is the index value of India stored in the index table), Karnataka by 20 (which is the index value of Karnataka stored in the index table) and Bangalore by 080 (which is the index value of Bangalore stored in the index table), although the data optimizing computing device 14 can replaces the indexed data with other values.

In step 615, the data optimizing computing device 14 identifies one or more repeated data within the obtained data illustrated in FIG. 4 and optimizes the identified repeated data. By way of example only, the repeated data relates to information that is being repeated throughout the obtained data, although repeated data can relate to other types or amounts of information within the obtained data. In this example, the data optimizing computing device 14 replaces the repeated data with a numerical value and stores the repeated data and the corresponding threshold value in a configuration file, although the data optimizing computing device 14 can optimize repeated data using other techniques. In this example, the data optimizing computing device 14 identifies “AddresslD: 0x123456” referenced by 406 in FIG. 4 as repeated data and replaces the repeated data with “AID” and indexes “AID” to “AddressID:0x123456” in the configuration file, although the data optimizing computing device 14 can replace the repeated data using other values.

In step 620, the data optimizing computing device 14 identifies and optimizes computational data within the obtained data illustrated in FIG. 4. By way of example only, the computational data relates to information within the obtained data that requires mathematical computation such as addition, multiplication, division or subtraction, although computational data can relate to other types or amounts of data within the obtained data that requires complex calculations. In this example, the data optimizing computing device 14 optimizes computational data by replacing the computational data by the corresponding result of the computational data, although the data optimizing computing device 14 can optimize the computational data using other techniques. Additionally, the data optimizing computing device 14 stores the computational data associated with the result in the configuration file so that the actual computational data can be easily identified when there is a requirement. In this example, the data optimizing computing device 14 identifies “Annual_Turnover: 100,000+75,000” referenced by 408 as computational data and replaces the identified computational data with the result “175,000” and indexes “175,000” to “100,000+75,000” in the configuration file so that “175,000” be easily replaced with “100,000+75,000” when required.

In step 625, the data optimizing computing device 14 identifies one or more information within the obtained data illustrated in FIG. 4 that can be optimized by abbreviating. By way of example only, information such as email address relates to information that can be abbreviated, although other types or amounts of information within the obtained data can also be abbreviated. In this example, the data optimizing computing device 14 replaces the email address with abbreviated information and indexes the abbreviated information and the corresponding email address (actual information) in a configuration file so that the abbreviated information can be replaced with the actual information, although the data optimizing computing device 14 can optimize using other techniques. In this example, the data optimizing computing device 14 identifies “Emailid:employee1@companyorganization.in” referenced by 410 in FIG. 4 and replaces with abbreviated information employee1@co.in upon optimizing.

In step 630, the data optimizing computing device 14 identifies and replaces column information to optimize the obtained data. By way of example only, the column information relates to entity columns present within the obtained data, although column information can relate to other types or amounts of information present within the obtained data. In this example, the data optimizing computing device 14 creates an object signature based on the column information and replaces the column information with the created object signature to optimize the data, although the data optimizing computing device 14 can optimize the column information using other techniques.

In step 635, the data optimizing computing device 14 identifies and optimizes image data within the obtained data. By way of example only, image data in this example relates to one or more images present within the obtained data, although image data can relate to other types or amounts of information within the obtained data. In this example, the data optimizing computing device 14 optimizes the image data by selecting only the object within image and deleting the background within the image using existing visual application programming interface (API's) know to person having ordinary skill in the art, although the data optimizing computing device 14 can optimize image data using other techniques such as compressing the image using image compression algorithms know to a person having ordinary skill in the art or crop the images to reduce the size of the image.

In step 640, the data optimizing computing device 14 identifies and optimizes video data within the obtained data. By way of example only, the video data relates to one or more videos present within the obtained data, although the video data can relate to other types or amounts of information present within the obtained data. In this example, the data optimizing computing device 14 optimizes video data by selecting only the required object or the foreground within the video and delete the background section, although the data optimizing computing device 14 can optimize the data using other techniques such as compressing the videos within the obtained data using video compression algorithms know to a person having ordinary skill in the art.

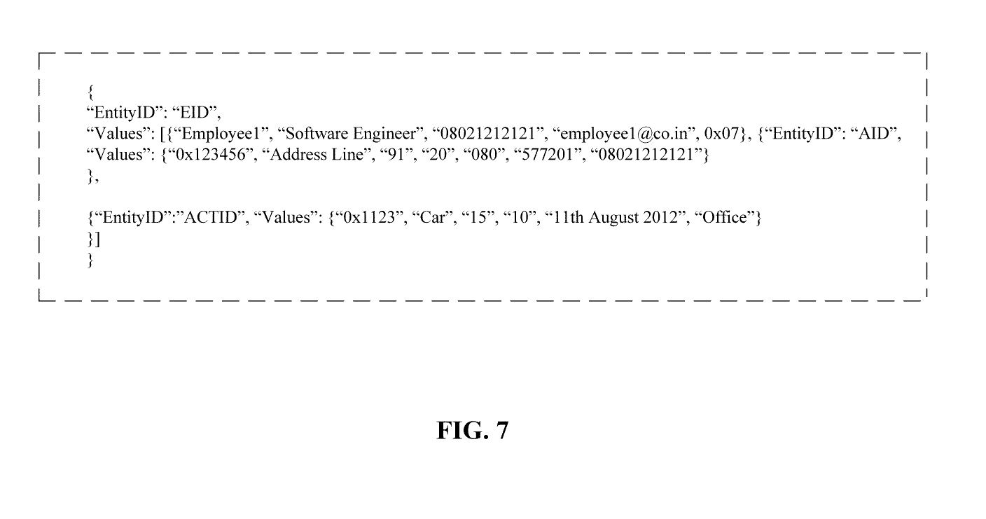

Now with reference to step 330 of FIG. 3, the data optimizing computing device 14 inserts the optimized data illustrated in FIG. 7 within a frame to prepare for the transmission of the optimized data, although the data optimizing computing device 14 can prepare the optimizing code for transmission using other techniques.

Next in step 335, the data optimizing computing device 14 generates a client code for the optimized data illustrated in FIG. 7 in a .java format, although the data optimizing computing device 14 can generate the client code in other formats. In this example, the client code generated by the data optimizing computing device 14 assists with converting the optimized data illustrated in FIG. 7 to be displayed in the actual format of the obtained data illustrated in FIG. 4 when the client code is executed by the requesting client computing device 12(1)-12(n).

In step 340, the data optimizing computing device 14 generates a server code for the optimized data illustrated in FIG. 7 in a .java format, although the data optimizing computing device 14 can generate the server code in other formats. In this example, the server code generated by the data optimizing computing device 14 assists with converting the optimized data illustrated in FIG. 7 to be displayed in the actual format of the obtained data illustrated in FIG. 4 when the server code is executed by servers 16(1)-16(n).

In step 345, the data optimizing computing device 14 transmits the generated server code to one of the servers 16(1)-16(n).

In step 350, the data optimizing computing device 14 transmits the client code generated in step 335 to the requesting client computing device 12(1)-12(n). By way of example only, the client computing device 12(1)-12(n) can executed the transmitted client code using one or more applications installed within the client computing device 12(1)-12(n) to view the optimized data set. Alternatively in another example, the step of transmitting the generated client code could be optional as the requesting client computing device 12(1)-12(n) may use any of the previously generated client code for purpose of viewing the optimized data set.

In step 355, the data optimizing computing device 14 transmits the data initially requested by the client computing device 12(1)-12(n) in the optimized format. In this example, the client computing device 12(1)-12(n) upon executing the client code transmitted in step 350 can view the optimized data illustrated in FIG. 7 in an actual format of the data originally obtained by the data optimizing computing device 14 illustrated in FIG. 4 and the exemplary method ends at step 360. Alternatively in another example, the client computing device 12(1)-12(n) can execute any of the previously transmitted client code for the purpose of viewing the optimized data in an actual format.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for optimizing data for transmission, the method comprising:
obtaining, by a data optimizing computing device, data set for transmission;
obtaining, by the data optimizing computing device, one or more configuration rules associated with the obtained data set;
optimizing, by the data optimizing computing device, the obtained data set based on the obtained one or more configuration rules for transmission;
generating, by the data optimizing computing device, a client code and a server code associated with the optimized data set; and
transmitting, by the data optimizing computing device, at least one of the generated client code to a client computing device or the server code to a server computing device.

2. The method as set forth in claim 1 further comprising transmitting, by the data optimizing computing device, the other one of the generated client code to the client computing device or the server code to the server computing device.

3. The method as set forth in claim 1 further comprising transforming, by the data optimizing computing device, the obtained data set into one or more of a extensible markup language (XML) format or a JavaScript object notion (JSON) format.

4. The method as set forth in claim 1 further comprising storing, by the data optimizing computing device, the optimized data set in a data frame to prepare for transmission of the transformed data.

5. The method as set forth in claim 4 further comprising transmitting, by the data optimizing computing device, the transformed data in the data frame to the client computing device.

6. The method as set forth in claim 1 wherein the one or more configuration rules comprises one or more rules for primitive data optimization, one or more rules for data redundancy optimization, one or more rules for string data optimization, one or more rules for computational data optimization, one or more rules for abbreviation data optimization, one or more rules for index data optimization, one or more rules for image data optimization, or one or more rules for column data optimization.

7. A data optimizing computing device comprising:
one or more processors;
a memory, wherein the memory coupled to the one or more processors which are configured to execute programmed instructions stored in the memory comprising:
obtaining data set for transmission;
obtaining one or more configuration rules associated with the obtained data set;
optimizing the obtained data set based on the obtained one or more configuration rules for transmission;
generating a client code and a server code associated with the optimized data set; and
transmitting at least one of the generated client code to a client computing device or the server code to a server computing device.

8. The device as set forth in claim 7 wherein the one or more processors is further configured to execute programmed instructions stored in the memory further comprising transmitting the other one of the generated client code to the client computing device or the server code to the server computing device.

9. The device as set forth in claim 7 wherein the one or more processors is further configured to execute programmed instructions stored in the memory further comprising transforming, by the data optimizing computing device, the obtained data set into one or more of a extensible markup language (XML) format or a JavaScript object notion (JSON) format.

10. The device as set forth in claim 7 wherein the one or more processors is further configured to execute programmed instructions stored in the memory further comprising storing the optimized data set in a data frame to prepare for transmission of the transformed data.

11. The device as set forth in claim 10 wherein the one or more processors is further configured to execute programmed instructions stored in the memory further comprising transmitting the transformed data in the data frame to the client computing device.

12. The device as set forth in claim 7 wherein the one or more configuration rules comprises one or more rules for primitive data optimization, one or more rules for data redundancy optimization, one or more rules for string data optimization, one or more rules for computational data optimization, one or more rules for abbreviation data optimization, one or more rules for index data optimization, one or more rules for image data optimization, or one or more rules for column data optimization.

13. A non-transitory computer readable medium having stored thereon instructions for optimizing data for transmission comprising machine executable code which when executed by at least one processor, causes the processor to perform steps comprising:
obtaining data set for transmission;
obtaining one or more configuration rules associated with the obtained data set;
optimizing the obtained data set based on the obtained one or more configuration rules for transmission;
generating a client code and a server code associated with the optimized data set; and
transmitting, by the data optimizing computing device, at least one of the generated client code to a client computing device or the server code to a server computing device.

14. The medium as set forth in claim 13 further comprising transmitting the other one of the generated client code to the client computing device or the server code to the server computing device.

15. The medium as set forth in claim 13 further comprising transforming, by the data optimizing computing device, the obtained data set into one or more of a extensible markup language (XML) format or a JavaScript object notion (JSON) format.

16. The medium as set forth in claim 13 further comprising storing the optimized data set in a data frame to prepare for transmission of the transformed data.

17. The medium as set forth in claim 16 further comprising transmitting the transformed data in the data frame to the client computing device.

18. The medium as set forth in claim 13 wherein the one or more configuration rules comprises one or more rules for primitive data optimization, one or more rules for data redundancy optimization, one or more rules for string data optimization, one or more rules for computational data optimization, one or more rules for abbreviation data optimization, one or more rules for index data optimization, one or more rules for image data optimization, or one or more rules for column data optimization.
